(19) United States
(12) Patent Application Publication
(10) Pub. No.: US 2005/0006405 A1
(43) Pub. Date: Jan. 13, 2005

(54) Bottled type water dispenser

(76) Inventor: Chang Kuei Tang, Banchiau City (TW)

Correspondence Address: Yi-Wen Tseng, 509 ROOSEVELT BLVD. #D306, FALLS CHURCH, VA, 22044, US

(21) Appl. No.: 10/614,030

(22) Filed: Jul. 8, 2003

(51) Int. Cl. B67D 5/62

(52) U.S. Cl. 222/146.6; 222/185.1

(57) ABSTRACT

A bottled type water dispenser, having a water tank and a body each having an open top. A detachable seat of water inlet and venting pipe is mounted on each opening. The seat of water inlet and venting pipe is directly engaged with the body, while a sealing member is installed between the seat of water inlet and venting pipe and the water tank. The seat of water inlet and venting pipe includes a water inlet and venting pile, allowing the mouth of a bottle inserted therein. Further, a one-way valve is installed at a top portion of the tank, such that air can flow into a shell, while water cannot flow out of the tank via such one-way valve.

### BACKGROUND OF THE INVENTION

The present invention relates generally to a bottled type water dispenser and, more particularly, to a unitary seat of water inlet and venting pipe of a bottled type water dispenser. The bottled type water dispenser is easily fabricated and assembled, and the interior thereof is easily cleaned.

The conventional water dispenser typically includes a filter mechanism installed on a bottled type water storage device. The water storage device is inversely disposed on/in the water dispenser, allowing water contained therein to flow into the water dispenser. For example, in U.S. Pat. No. 6,123,232, the water dispenser includes a generally cylindrical liquid reservoir normally open at its upper end for receiving liquid from an inverted bottle having a downwardly and inwardly sloping shoulder portion merging into a depending neck portion defining a discharge opening, said liquid dispensing device comprising, in combination, a top support having a generally centrally disposed annular opening with a depending skirt portion dimensioned for reception in the open upper end of said reservoir, said top support defining a generally annular ring portion for supporting said shoulder portion of said inverted bottle above said liquid reservoir and wherein said top support includes a downwardly extending peripheral margin for generally centering said annular opening over said reservoir, a feed tube comprising a generally cylindrical outer portion and a substantially hollow interior defining at least one flow path for dispensing liquid from said inverted bottle into said reservoir and for admitting replacement air from said reservoir into said bottle, means for mounting said feed tube in upstanding relation in the upper portion of said reservoir, said mounting means including a cup-shaped structure formed integrally with and supporting said upstanding feed tube in generally centered relation with respect to said annular opening and said reservoir, said cup-shaped structure having an inwardly stepped sidewall and an upper portion for suspending said integral feed tube and cup-shaped structure from said top support, and means defining an opening through said cup-shaped structure radially outwardly from said feed tube for admitting air into the upper end of said reservoir.

In the above-mentioned conventional water dispenser, the top support, the feed tube and the cup-shaped structure are all independent members requiring opening multiple molds for fabrication. Some of such members are difficult to install, and too many separate members also cause inconvenience of assembly. Further, it is very laborious and time-consuming for cleaning the internal storage tank or the cold or hot water tub since all of the members have to be detached from the water dispenser.

### BRIEF SUMMARY OF THE INVENTION

The present invention provides a bottle type water dispenser which can be easily fabricated, assembly and used.

The bottle type water dispenser provided by the present invention includes a water tank in a body thereof. The body and the water tank each have an opening. A detachable seat of water inlet and venting pipe is installed on the openings. The seat of water inlet and venting pipe includes an integrally formed structure and is directly connected to the body. The seat of water inlet and venting pipe includes a water inlet and venting pipe, allowing a mouth of the water bottle inserted therein. Therefore, as the water assembly requires only the connection of the seat of water inlet and venting pipe, the body and the water tank, it is easily dissembled to clean the water tank.

An air inlet port is formed on a top portion of the water tank. A one-way valve is mounted at the air inlet port. When the water tank has a full water level, the one-way valve is pressurized by the water to block the air inlet port. Therefore, no water or air can flow through the air inlet port. When the water level drops, the one-way valve falls due to gravitation to leave the air inlet port open. Therefore, air flows from the air inlet port allowing fluent water dispense.

The present invention is further characterized in applying a sealing member between the seat of water inlet and venting pipe and the water tank. The sealing member includes a circular sealing ring.

### BRIEF DESCRIPTION OF THE DRAWINGS

These, as well as other features of the present invention, will become more apparent upon reference to the drawings wherein:

FIG. 1 shows a perspective view of a water dispenser provided by the present invention;

FIG. 2 shows an exploded view of a seat of water inlet and venting tube provided by the invention;

FIG. 3 shows a cross sectional view of the internal assembly of the water dispenser provided by the present invention;

FIG. 4 shows a schematic view of full water level of a water tank when the water dispenser is in use; and

FIG. 5 shows a schematic view for water flowing into the water tank.

### DETAILED DESCRIPTION OF THE INVENTION

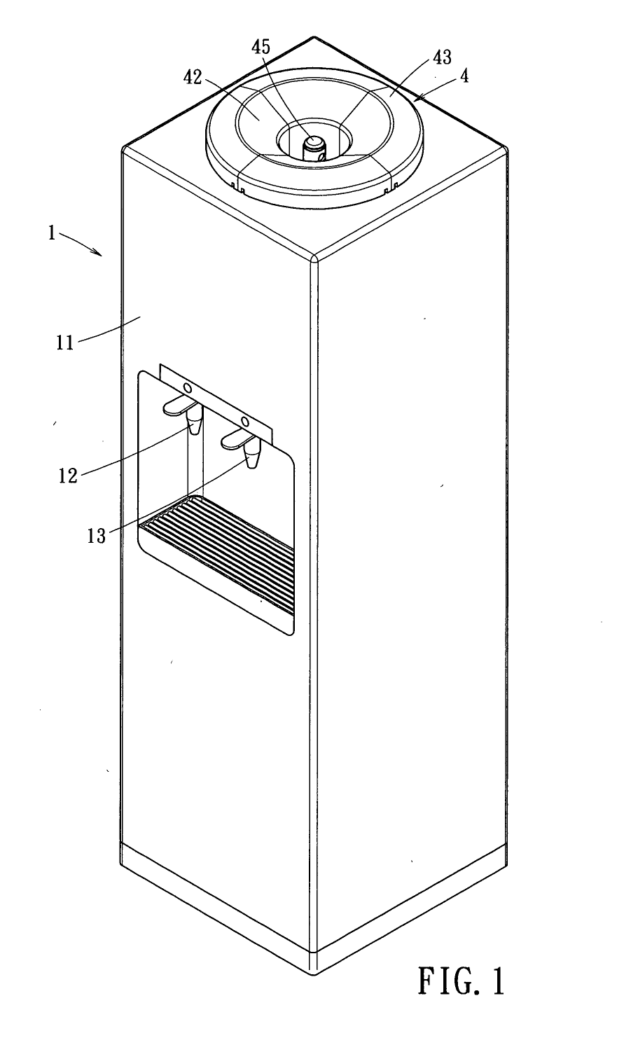

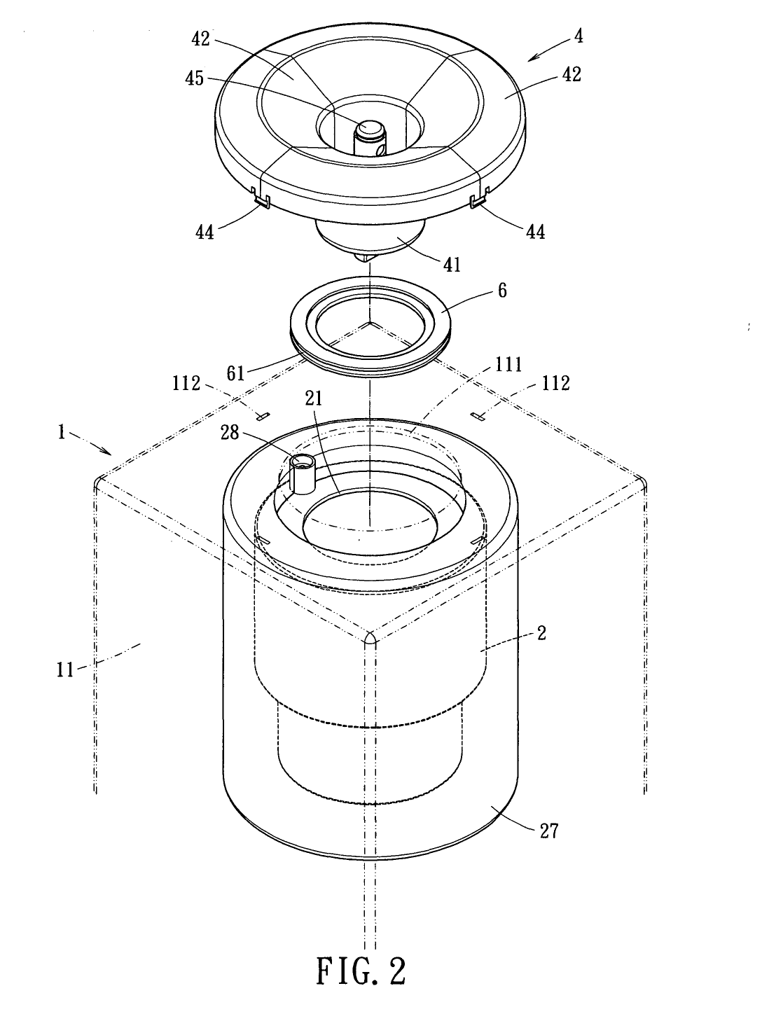

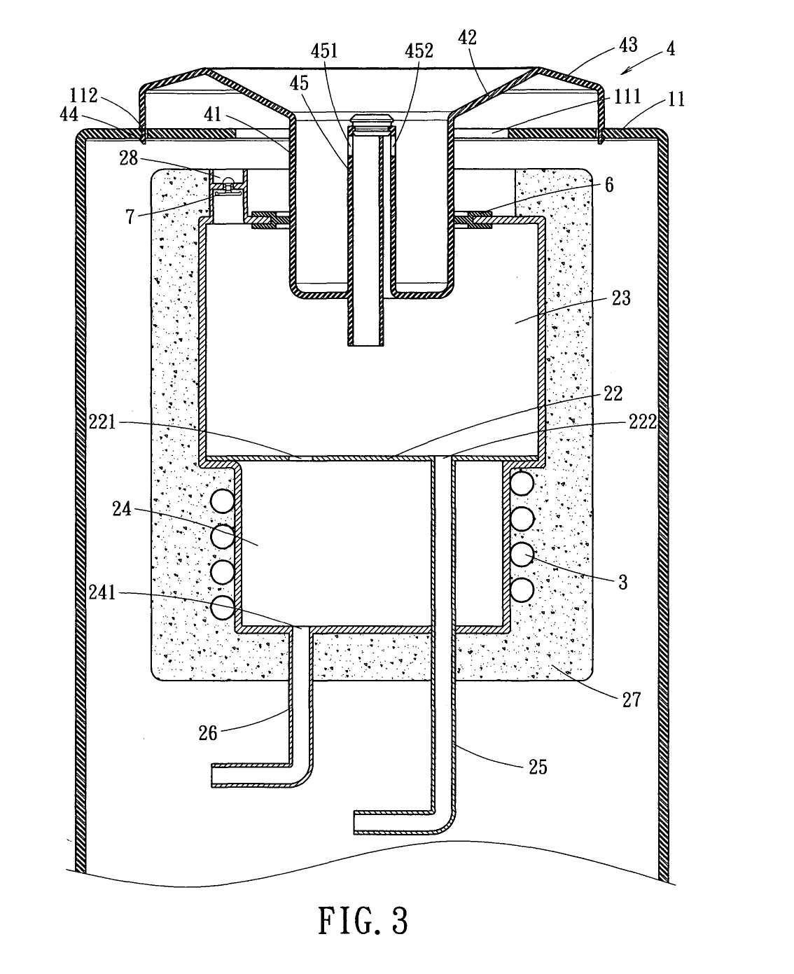

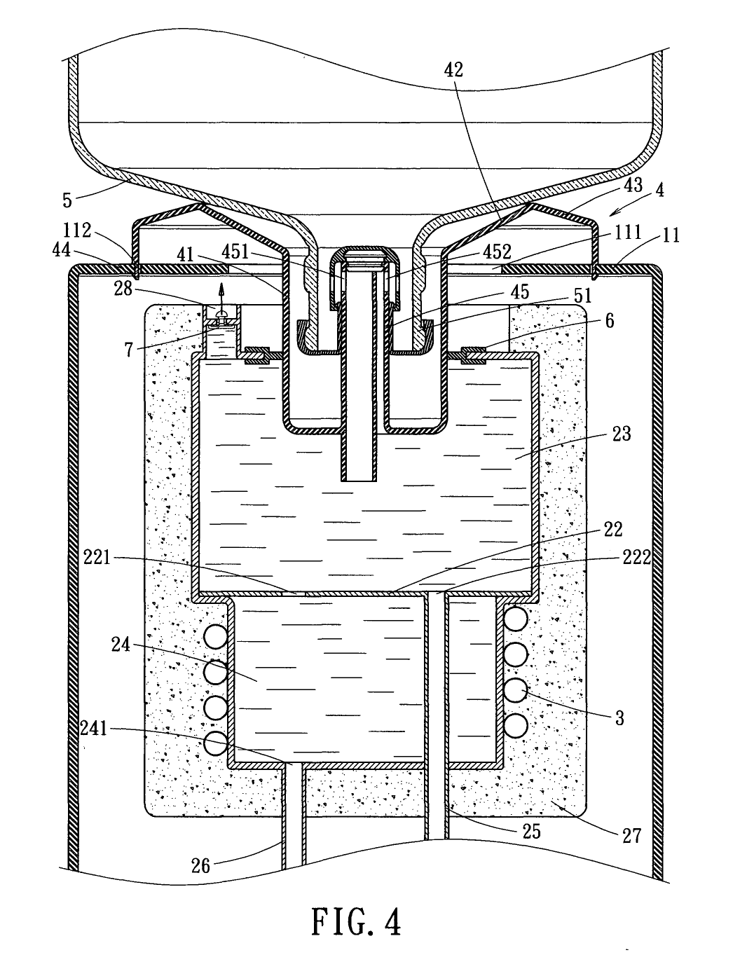

Referring to FIGS. 1 and 4, a water bottle 5 filled with water is installed on top of a water dispenser 1 to provide drinking water for the water dispenser 1. As shown in FIGS. 2 and 3, the body 11 of the water dispenser 1 includes a water tank 2 at a top portion thereof. The body 11 and the water tank 2 have an opening 111 and 21, respectively. The water tank 2 is partitioned into an upper chamber 23 and a lower chamber 24 by a partitioning board 22. Two outlet apertures 221, 222 are formed on the partitioning board 22. The outlet aperture 221 allows the water contained in the upper chamber 23 flowing into the lower chamber 24, while the other outlet aperture 222 is connected to a water tap12 or a hot water tub via a an outlet pipe 25 as shown in FIG. 1. A cooler 3 is formed on the exterior wall of the lower chamber 24, such that water contained in the lower chamber 24 is cooled down to become cold water. An outlet aperture 241 is formed on a bottom portion of the lower chamber 24. The outlet aperture 241 is connected to a water tap 13 (as shown in FIG. 2) via an outlet pipe 26. The water tank 2 is covered with shielding material 27 such as polyfoam.

Referring to FIGS. 2 and 3, in the present invention, a detachable seat of water inlet and venting pipe is installed at the openings 111, 21 of the body 11 and the water tank 2. The seat of water inlet and venting pipe 4 includes a U-shape seat 41 with a predetermined depth allowing the mouth 51 of the water bottle 5 inserted therein. The periphery of a top portion of the U-shape seat 41 extends outwardly and inclined upwardly to form a contact surface 42. The free end of the contact surface 42 further extends to form an inverse L-shape fastening part 43. A plurality of equal distant latches 44 are formed on a bottom end of the fastening part 43, while apertures 112 are formed on the body 11 for receiving the latches 44.

In the present invention, a hollow water inlet and venting pipe 45 extends from a central bottom portion of the U-shape seat 41. The water inlet and venting pipe 45 includes a water inlet aperture 451 and a venting aperture 452 on a sidewall thereof. A sealing member is mounted between the water inlet and venting pipe 4 and the water tank 2. In one embodiment, the sealing member includes a circular sealing ring 6, of which a clipping socket 61 is formed on an exterior sidewall thereof to be engaged with a rim of the opening 21 of the water tank 2. Thereby, the sealing ring 6 seals the tank 2 and the water inlet and venting pipe 4.

Referring to FIG. 3, in the present invention, an air inlet port 28 is formed on the top portion of the water tank 2. A one-way valve 7 is mounted on the air inlet port 28. When the water tank 2 has a full water level, the water level push the one-way valve 7 upwardly, such that the air inlet port 28 is filled by the one-way valve 7, and water in the water tank 2 cannot overflows through the air inlet port 28. When the water tap 12 (or 13) of the water dispenser 1 is switched on, water level drops to release pressure against the one-way valve 7. The one-way valve 7 thus descends due to gravitation, such that air flows in through the air inlet port 29, and water flow is fluent.

Referring to FIGS. 2 and 3, while assembly the water dispenser, the seat of water inlet and venting pipe 4 is installed on the openings 111, 21 of the body 11 and the water tank 2. The sealing ring 6 is mounted on a periphery of the U-shape seat 41. The clip socket 61 formed on the exterior side of the sealing ring 6 is engaged with the edge of the opening 21 of the water tank 2. Therefore, the water tank 2 and the seat of water inlet and venting pipe 4 are sealed. The latching members 44 formed on the latching portion 43 of the seat of water inlet and venting pipe 4 are received in the apertures 112, such that a water inlet and venting pipe 45 is installed on top of the water dispenser 1 and connected to the body 11 and the water tank 2.

When the water dispenser 1 is in use, as shown in FIG. 4, the mouth 51 of the water bottle 5 is inversely inserted into the U-shape body 41, such that the water inlet and venting tube 45 is inserted into the mouth 51, allowing water flowing from the water bottle 5 into the water tank 2 through the water inlet aperture 451 of the water inlet and venting pipe 45, and air flowing from the water tank 2 to the water bottle 5 through the venting aperture 452. By the air pressure, water in the water bottle 5 flows into the water tank 2, while water contained in the upper chamber 23 flows to the lower chamber 24 through the water outlet aperture 221 of the partitioning board 22. The water in the lower chamber 24 is cooled down by the cooler 3, while water in the upper chamber 23 is fed into a hot water tube for via a pipe 25 for heating. The water dispenser 1 thus can provide cold water and cold water.

In the present invention, once the water tank 2 has a full water level, the water push against the one-way valve to block the air inlet port 28. Therefore, water in the water tank 2 will not overflows the body 11, and external air will not enter the water tank 2 through the air inlet port 28 as shown in FIG. 4.

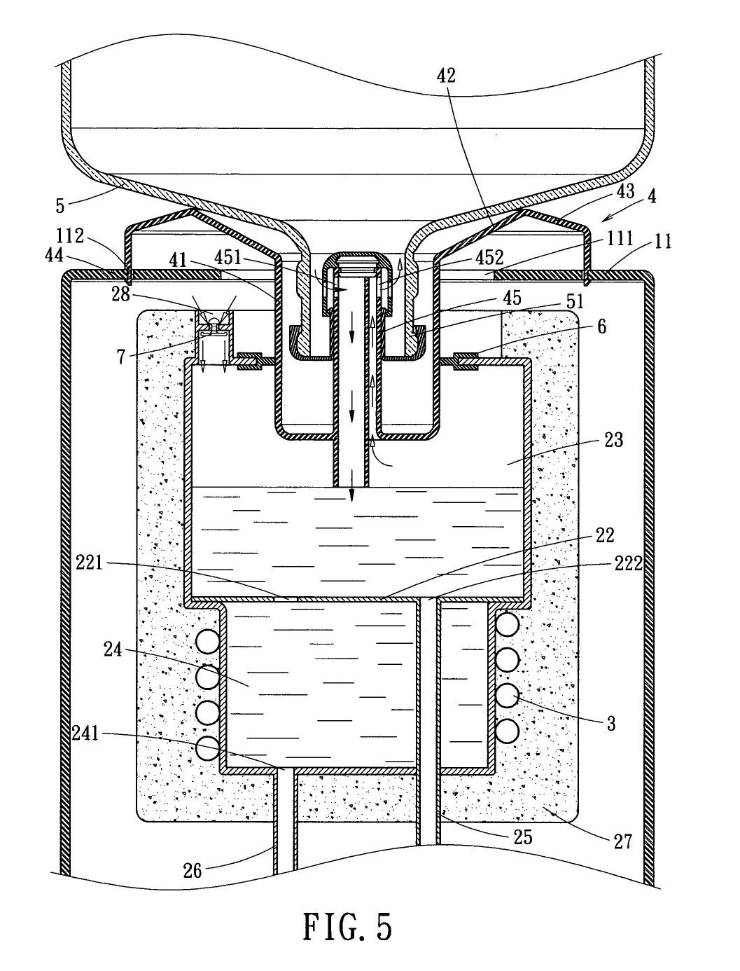

As shown in FIG. 5, once eh tap 12 (or 13) of the water dispenser 1 is switched on and water level of the water tank 2 drops, the upward pressure against the one-way valve 7 no longer exists. The one-way valve 7 thus falls by gravitation and releases from the air inlet port 28. Therefore, air can enters the water tank 2, allowing fluent flow of water dispense from the tap 12 (or 13).

In the present invention, a unitary seat of water inlet and venting pipe is used to conveniently assemble the body 11 and the water tank 2 together. To clean the water tank 2, only by detaching the seat of water inlet and venting pipe 4, the openings 111, 21 of the body 11 and 2 are exposed, and the water tank 2 can be easily cleaned.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

1. A bottled type water dispenser, on which a water bottle is installed, the water dispenser, comprising:
a body, having a opening at the top portion thereof;
a water tank in the top portion of the body and having an opening at a top thereof, the water tank being connected to a tap via a pipe; and
a seat of water inlet and venting pipe, detachably installed at the openings of the body and the water tank by latching devices formed on the seat of water inlet and venting pipe and the body; and
a sealing member to seal the water tank.

2. The water dispenser of claim 1, wherein the water tank is partitioned into an upper chamber and a lower chamber by a partitioning board, the partitioning board includes one water outlet aperture allowing water flowing from the upper chamber to the lower chamber, and another water outlet aperture connected to a tap or a hot water tube via an outlet pipe, the lower chamber further comprises a outlet port connected to another tape via another outlet pipe.

3. The water dispenser of claim 2 further comprising a cooler on an exterior wall of the lower chamber to cool the water contained in the lower chamber into cold water.

4. The water dispenser of claim 1, further comprising a thermal insulating material around the water tank.

5. The water dispenser of claim 1, wherein the seat of water inlet and venting pipe further comprises a U-shape seat with a predetermined depth allowing a mouth of the water tank to be inserted therein, a hollow water inlet and venting pipe extending from a bottom center of the U-shape seat, the water inlet and venting pipe includes a water inlet aperture and a venting pipe on a sidewall thereof, a upwardly-inclined contact surface extending from a top edge, and an inverse L-shape latching part extending from a free end of the contact surface.

6. The water dispenser of claim 1, wherein the latching member includes a plurality of equal distant latching devices formed on a bottom edge of the seat of water inlet and venting pipe, and a plurality of latching apertures for receiving the corresponding latching devices.

7. The water dispenser of claim 5, wherein the latching member includes a plurality of equal distant latching devices formed on the latching part and a plurality of latching apertures for receiving the corresponding latching devices.

8. The water dispenser of claim 1, wherein the sealing member includes a circular sealing ring and a clip socket on an external side for engaging the edge of the opening of the water tank.

9. The water dispenser of claim 1, further comprising an air inlet port formed on the top portion of the water tank, such that when the water tank has a full water level, the one-way valve is pressurized by water to block the water inlet port, and when the water level is lowered, the one-way valve is released from the air inlet port allowing air to flow into the water tank.
